(19) United States
(12) Patent Application Publication
(10) Pub. No.: US 2014/0239220 A1
(43) Pub. Date: Aug. 28, 2014

(54) FE-BASED, PRIMARY, ULTRAFINE CRYSTALLINE ALLOY RIBBON AND MAGNETIC DEVICE

(71) Applicant: HITACHI METALS, LTD., Minato-ku, Tokyo (JP)

(72) Inventors: Masamu Naoe, Tottori-shi (JP); Michihiro Nagao, Yasugi-shi (JP)

(73) Assignee: HITACHI METALS, LTD., Minato-ku, Tokyo (JP)

(21) Appl. No.: 14/349,808

(22) PCT Filed: Oct. 9, 2012
(86) PCT No.: PCT/JP2012/076138

§ 371 Date: Apr. 4, 2014

(30) Foreign Application Priority Data
Oct. 6, 2011 (JP) 2011-222057

(51) Int. Cl. H01F 1/01

(52) U.S. Cl. CPC H01F 1/01
USPC 252/62.55; 428/401

(57) ABSTRACT

An Fe-based, primary, ultrafine crystalline alloy ribbon having a composition represented by the general formula of Fe_{100-x-y-z-a-b}NiₓCu_{y}Nb_{z}SiₐB_{b}, wherein x, y, z, a and b are numbers (atomic %) meeting the conditions of 4≦x≦6, 0.1≦y≦2, 0.1≦z≦4, 7≦a≦18, and 4≦b≦12; an as-cast structure in which fine crystal grains having a grain size distribution of 300 nm or less are dispersed in a proportion of more than 0% and 7% or less by volume in an amorphous matrix; and a thickness of 13-23 μm.

### FIELD OF THE INVENTION

The present invention relates to an Fe-based, primary, ultrafine crystalline alloy ribbon dividable to desired widths by slitting without fracture, and a magnetic device formed by an Fe-based, nano-crystalline, soft-magnetic alloy ribbon obtained by heat-treating it.

### BACKGROUND OF THE INVENTION

Because Fe-based, nano-crystalline, soft-magnetic alloy ribbons have excellent soft-magnetic properties, they are used for magnetic cores for common mode choke coils, high-frequency transformers, pulse transformers, etc. The Fe-based, nano-crystalline, soft-magnetic alloy ribbons are obtained by quenching liquid or gas phases to form amorphous alloys, and then heat-treating them at temperatures equal to or higher than their crystallization temperatures to form fine crystals having an average grain size of about 100 nm or less. In mass production, they are produced by forming amorphous alloy ribbons by quenching their melts by a single roll method, winding them to core shapes, and then heat-treating them.

For example, JP-74419 B discloses a method for producing an Fe-based, soft-magnetic alloy having a composition represented by the general formula of (Fe₁₋ₐMₐ)_{100-x-y-z-α-γ}CuₓSi_{y}B_{z}M′_{α}X_{γ} (atomic %), wherein M is Co and/or Ni, M′ is at least one element selected from the group consisting of Nb, W, Ta, Zr, Hf, Ti and Mo, X is at least one element selected from the group consisting of C, Ge, P, Ga, Sb, In, Be and As, and a, x, y, z, a and y meet 0≦a 0.5, 0.1≦x≦3, 0≦y≦30, 0≦z≦25, 5≦y+z≦30, 0.1≦α≦30, and γ≦10, and a structure comprising at least 50% of fine crystal grains having an average grain size of 1000 Å or less, the balance being substantially an amorphous phase; which comprises the steps of forming an amorphous alloy having the above composition by a melt-quenching or vapor-quenching method, and heat-treating the amorphous alloy at 405-700° C. for 5 minutes to 24 hours to form fine crystal grains having an average grain size of 1000 Å or less. This Fe-based, nano-crystalline, magnetic alloy has high relative permeability and low loss. It has been found, however, that when it is used for magnetic cores for noise reduction parts in large-current inverters in wind power generators or high-speed electric trains, it is easily saturable magnetically in a large current region because of relative high permeability.

Instead of producing an Fe-based, soft-magnetic alloy with fine crystal grains precipitated by the heat treatment of an Fe-based, amorphous alloy, a method of forming an Fe-based, ultrafine-crystalline alloy with ultrafine crystals precipitated, and heat-treating it to form a nano-crystalline, magnetic alloy having a high saturation magnetic flux density and excellent soft-magnetic properties has been proposed. WO 2007/032531 discloses a nano-crystalline, magnetic alloy having a composition represented by the general formula of Fe_{100-x-y-z}CuₓB_{y}X_{z}, wherein X is at least one element selected from the group consisting of Si, S, C, P, Al, Ge, Ga and Be, and x, y and z are numbers (atomic %) meeting the conditions of 0.1≦x≦3, 10≦y≦20, 0<z≦10, and 10<y+z≦24, a structure comprising crystal grains having an average grain size of 60 nm or less in an amorphous matrix, and a saturation magnetic flux density of 1.7 T or more. This nano-crystalline, magnetic alloy is produced by a method comprising quenching an alloy melt comprising Fe and metalloid elements to form an Fe-based, alloy having a structure in which crystal grains having an average grain size of 30 nm or less are dispersed in a proportion of more than 0% and 30% or less by volume in an amorphous matrix, and heat-treating the Fe-based, alloy to provide it with a structure, in which crystal grains having an average grain size of 60 nm or less having a body-centered cubic structure are dispersed in a proportion of 30% or more by volume in an amorphous matrix.

WO 2007/032531 describes that in this nano-crystalline, magnetic alloy, 10 atomic % or less of Fe may be substituted by Ni and/or Co, and that 5 atomic % or less of Fe may be substituted by at least one element selected from the group consisting of Ti, Zr, Hf, V, Nb, Ta, Cr, Mo, W, Mn, Re, platinum-group elements, Au, Ag, Zn, In, Sn, As, Sb, Bi, Y, N, O and rare earth elements. However, the Ni contents are as small as 2 atomic % at most in nano-crystalline, magnetic alloys produced in Examples in WO 2007/032531, and none of them contain both Ni and Nb. Also, the nano-crystalline, magnetic alloy ribbons are as narrow as 5 mm in width.

From the aspect of productivity, it is preferable to produce a nano-crystalline, magnetic alloy ribbon as wide as possible with uniform thickness, and divide it to desired widths by slitting. It has been found, however, that a nano-crystalline, magnetic alloy ribbon with a Ni content of 2 atomic % or less cannot be easily formed with a large width and uniform thickness by a single roll method, and that it is frequently fractured by slitting because of extreme brittleness. This is due to the fact that because a center portion of a cooling roll in a width direction is expanded with heat of the alloy melt, the gap between a nozzle and the cooling roll is smaller in the width-direction center portion, resulting in an alloy ribbon thinner in the width-direction center portion than in both side edge portions. Also, because an alloy ribbon with a small Ni content contains fine crystal grains at a high volume fraction, it has low toughness, easily fracturable by slitting.

### OBJECT OF THE INVENTION

Accordingly, an object of the present invention is to provide an Fe-based, primary, ultrafine crystalline alloy ribbon having uniform thickness even with a large width, and dividable to desired widths by slitting without fracture, and a magnetic device formed by an Fe-based, nano-crystalline, soft-magnetic alloy ribbon obtained by heat-treating it.

### DISCLOSURE OF THE INVENTION

As a result of intensive research in view of the above object, it has been found that when an alloy melt containing a relatively large amount of Ni and a proper amount of Nb in addition to Fe, Cu, Si and B is quenched under such a condition as to form fine crystal grains, an alloy ribbon having uniform thickness even with a large width and dividable to desired widths by slitting without fracture can be formed by adjusting the Ni content and the thickness to desired ranges. The present invention has been completed based on such findings.

Thus, the Fe-based, primary, ultrafine crystalline alloy ribbon of the present invention has a composition represented by the following general formula:

Fe_{100-x-y-z-a-b}NiₓCu_{y}Nb_{z}SiₐB_{b},

wherein x, y, z, a and b are numbers (expressed by atomic %) meeting the conditions of 4≦x≦6, 0.1≦y≦2, 0.1≦z≦4, 7≦a≦18, and 4≦b≦12;

an as-cast structure in which fine crystal grains having a grain size distribution of 300 nm or less are dispersed in a proportion of more than 0% and 7% or less by volume in an amorphous matrix; and

a thickness of 13-23 μm.

In the Fe-based, primary, ultrafine crystalline alloy ribbon, the fine crystal grains preferably have an average grain size of 80 nm or less.

x preferably meets the condition of 4.5≦x≦5.3. The proportion of the fine crystal grains to the entire alloy structure is preferably more than 0% and 3.5% or less by volume. The alloy ribbon preferably has a thickness of 14-22 μm.

The magnetic device of the present invention is formed by an Fe-based, nano-crystalline, soft-magnetic alloy ribbon obtained by heat-treating the above Fe-based, primary, ultrafine crystalline alloy ribbon at a temperature equal to or higher than its crystallization temperature after slit to a desired width; the Fe-based, nano-crystalline, soft-magnetic alloy ribbon having a structure in which fine crystal grains having an average grain size of 20-100 nm are dispersed in a proportion of 50% or more by volume in an amorphous matrix.

### BRIEF DESCRIPTION OF THE DRAWINGS

FIG. 1 is a schematic view showing one example of methods of slitting an Fe-based, primary, ultrafine crystalline alloy ribbon.

### DESCRIPTION OF THE PREFERRED EMBODIMENTS

[1] Fe-Based, Soft-Magnetic Alloy Ribbon

(1) Composition

The Fe-based, primary, ultrafine crystalline alloy ribbon of the present invention has a composition represented by the following general formula:

Fe_{100-x-y-z-a-b}NiₓCu_{y}Nb_{z}SiₐB_{b},

wherein x, y, z, a and b are numbers (expressed by atomic %) meeting the conditions of 4≦x≦6, 0.1≦y≦2, 0.1≦z≦4, 7≦a≦18, and 4≦b≦12. Of course, the above composition may contain inevitable impurities.

The Fe-based, primary, ultrafine crystalline alloy ribbon of the present invention is characterized in containing 4-6 atomic % of Ni. The addition of Ni promotes to make the crystal structure finer, improving handleability (windability) and thus soft-magnetic properties. With Ni as much as 4-6 atomic %, fracture can be prevented in slitting. The preferred Ni content is 4.5-5.3 atomic %.

Cu is an element necessary for precipitating fine crystal grains. When the Cu content is less than 0.1 atomic %, a necessary amount of fine crystal grains are not precipitated by quenching the alloy melt, so that a heat treatment fails to provide a nano-crystalline structure in which fine crystal grains having an average grain size of 20-100 nm are dispersed at a volume ratio of 50% or more. On the other hand, when the Cu content is more than 2 atomic %, a cast alloy ribbon is so brittle that it cannot be slit without fracture. Accordingly, the Cu content is 0.1-2 atomic %. The preferred Cu content is 0.1-1 atomic %.

Nb is an element necessary for obtaining a nano-crystalline structure in which fine crystal grains having an average grain size of 20-100 nm are dispersed at a volume ratio of 50% or more after heat treatment. When the Nb content is 0.1 atomic %, the above effect cannot be obtained. On the other hand, when the Nb content is more than 4 atomic %, the Fe content is relatively low, resulting in poor soft-magnetic properties. Accordingly, the Nb content is 0.1-4 atomic %. The preferred Nb content is 0.3-3 atomic %.

When the amount of Si, an amorphousization element, is 7 atomic % or more, amorphousization stably occurs by quenching. However, when the Si content is more than 18 atomic %, the resultant alloy ribbon has a low saturation magnetic flux density. Accordingly, the Si content is 7-18 atomic %. The preferred Si content is 10.5-11.5 atomic %.

When the amount of B, an amorphousization (amorphous phase-forming) element, is 4 atomic % or more, amorphousization stably occurs by quenching. However, when the B content is more than 12 atomic %, the resultant alloy ribbon has a low saturation magnetic flux density. Accordingly, the B content is 4-12 atomic %. The preferred B content is 8-11 atomic %.

(2) Structure

The Fe-based, primary, ultrafine crystalline alloy ribbon of the present invention has an as-cast structure in which fine crystal grains having a grain size distribution of 300 nm or less are dispersed in a proportion of more than 0% and 7% or less by volume in an amorphous matrix. When the volume ratio of fine crystal grains is more than 7% by volume, the alloy ribbon is brittle, suffering a high frequency of fracturing starting from fine crystal grains in slitting. Fracture may occur when the alloy ribbon is rewound. On the other hand, without fine crystal grains, an amorphous alloy would be formed, failing to obtain soft-magnetic properties such as a high saturation magnetic flux density. The volume ratio of fine crystal grains is preferably 3.5% or less by volume, more preferably 3% or less by volume.

With respect to a grain size distribution, the existence of crystal grains having grain sizes of more than 300 nm lowers soft-magnetic properties, and increases the frequency of fracturing in slitting. The preferred grain size distribution of fine crystal grains is 0-150 nm. The average grain size of fine crystal grains is preferably 80 nm or less, more preferably 50 nm or less. With the average grain size of fine crystal grains exceeding 80 nm, fracturing would occur by slitting highly frequently. The more preferred average grain size of fine crystal grains is 10-50 nm.

The grain sizes and volume ratio of fine crystal grains are determined by image analysis on transmission electron photomicrographs (field: 1000 nm x 1000 nm) of a cast alloy ribbon, and averaged in three arbitrary fields. The area ratio of fine crystal grains in each field is regarded as a volume ratio. Observation by a transmission electron microscope has revealed that fine crystal grains are substantially spherical.

(3) Thickness

How easily the alloy ribbon is fractured in slitting depends on the Ni content and thickness of the alloy ribbon. Intensive investigation has revealed that when the Ni content is in a range of 4-6 atomic %, and when the thickness is in a range of 13-23 μm, the alloy ribbon enjoys a low frequency of fracturing in slitting. When the alloy ribbon is as thick as 14-22 μm, the frequency of fracturing is further low in slitting.

(4) Width

The Fe-based, primary, ultrafine crystalline alloy ribbon meeting the conditions that the Ni content is in a range of 4-6 atomic %, and that its thickness is in a range of 13-23 μm can substantially keep thickness uniformity even when it is as wide as 30 mm or more. Practically, the width of the Fe-based, primary, ultrafine crystalline alloy ribbon is preferably 50 mm or more.

To provide the Fe-based, primary, ultrafine crystalline alloy ribbon with a reduced thickness distribution in a width direction, it has been found that the adjustment of the gap between a nozzle and a cooling roll during casting is effective. Namely, too wide a gap between the nozzle and the roll provides the alloy ribbon with a cross section thicker in a center portion and thinner in side edge portions. Thickness difference provides the difference in a cooling speed, and thus the difference in the density of fine crystal grains, resulting in a hardness distribution in a width direction. Specifically, when an Fe-based, primary, ultrafine crystalline alloy ribbon of 40 mm or more in width and 13-23 μm in thickness is cast, a gap of 200-300 μm between the nozzle and the cooling roll provides a thickness distribution (maximum thickness−minimum thickness) of 2 μm or less in a width direction. To reduce the thickness distribution in a width direction, the gap between the nozzle and the cooling roll is preferably 150-270 μm.

[2] Production Method of Fe-Based, Primary, Ultrafine Crystalline Alloy Ribbon

(1) Alloy Melt

The alloy melt has a composition represented by Fe_{100-x-y-z-a-b}NiₓCu_{y}Nb_{z}SiₐB_{b}, wherein x, y, z, a and b are numbers (atomic %) meeting the conditions of 4≦x≦6, 0.1≦y≦2, 0.1≦z≦4, 7≦a≦18, and 4≦b≦12.

(2) Quenching of Melt

The alloy melt can be quenched by a single roll method. The melt temperature is preferably higher than the melting point of the alloy by 50-300° C. Specifically, the melt at about 1300-1400° C. is preferably ejected from the nozzle onto the cooling roll. The atmosphere in the single roll method is air or an inert gas (Ar, nitrogen, etc.) when the alloy does not contain active metals, and an inert gas (Ar, He, nitrogen, etc.) or vacuum when it contains active metals. To form an oxide coating on the surface, the melt is quenched preferably in an oxygen-containing atmosphere (for example, air).

The formation of fine crystal grains is closely related to the cooling speed and time of the alloy ribbon. Accordingly, one of means for controlling the volume fraction of fine crystal grains is to control the peripheral speed (casting speed) of the cooling roll. A higher peripheral speed of the roll results in a lower volume fraction of fine crystal grains, and a lower peripheral speed results in a higher volume fraction. The peripheral speed of the roll is preferably 20-45 m/s, more preferably 25-40 m/s. When the peripheral speed of the cooling roll is less than 20 m/s, the cooling speed is too slow, resulting in too much crystallization. When the peripheral speed of the cooling roll is more than 45 m/s, a melt (paddle) between the nozzle and the cooling roll is so unstable that it is easily scattered.

Materials for the cooling roll are suitably high-thermal-conductivity pure copper or copper alloys such as Cu—Be, Cu—Cr, Cu—Zr, Cu—Zr—Cr, etc. The cooling roll is preferably cooled by water. Because the cooling of the roll by water affects the volume fraction of fine crystal grains, it is effective to keep cooling water at a predetermined temperature.

(3) Adjustment of Gap

In a single roll method in which an alloy melt is cast onto a cooling roll rotating at a high speed, the melt is not solidified immediately on the roll, but keeps a liquid phase for about 10⁻⁸ seconds to about 10⁻⁶ seconds. A melt in this state is called “paddle.” The control of the paddle enables the adjustment of the thickness, cross section shape, etc. of the ribbon. With the gap between the nozzle and the cooling roll, the ejecting pressure and weight of the melt, etc. adjusted, the paddle can be controlled. Among them, the ejecting pressure and weight of the melt are difficult to adjust, because they may change depending on the amount of the remaining melt, the melt temperature, etc. On the other hand, the adjustment of the gap can easily be conducted by always feedbacking the monitored distance between the nozzle and the cooling roll. Accordingly, the adjustment of the gap is preferable to control the thickness, cross section shape, etc. of the Fe-based, primary, ultrafine crystalline alloy ribbon.

Generally, a wider gap provides better flow of the melt, effective for making the Fe-based, primary, ultrafine crystalline alloy ribbon thicker and preventing the collapse of the paddle. However, too wide a gap provides the alloy ribbon with a cross section shape thicker in a center portion and thinner in side edge portions, resulting in thickness difference. To suppress the thickness distribution in a width direction to 2 μm or less, the gap is preferably adjusted to 200-300 μm. Incidentally, a narrow gap can suppress the thickness distribution in a width direction, but easily clogs a nozzle slit. When the gap is more than 300 μm, the paddle is unstable.

(4) Ejection Conditions of Melt

As a condition for ejecting the melt, the nozzle slit preferably has a width of 0.4-0.6 mm. When the width of the nozzle slit is less than 0.4 mm, the nozzle slit is easily clogged. When the width of the nozzle slit is more than 0.6 mm, the ejection of the melt is unstable, so that the melt is easily scattered. The ejection pressure of the melt is preferably 200-300 g/cm². When the ejection pressure of the melt is less than 200 g/cm², the nozzle slit is easily clogged, resulting in unstable melt supply, and thus a rough ribbon surface. When the ejection pressure of the melt is more than 300 g/cm², a melt between the nozzle and the cooling roll is unstable, so that the melt is easily scattered.

(5) Stripping Temperature

With an inert gas (nitrogen, etc.) blown from a nozzle into a gap between the Fe-based, primary, ultrafine crystalline alloy ribbon formed by quenching and the cooling roll, the Fe-based, primary, ultrafine crystalline alloy ribbon is stripped from the cooling roll. The stripping temperature (related to the cooling time) of the Fe-based, primary, ultrafine crystalline alloy ribbon also affects the volume fraction of fine crystal grains. The stripping temperature of the Fe-based, primary, ultrafine crystalline alloy ribbon is generally 170-350° C., preferably 200-340° C., though it can be adjusted by the position (stripping position) of the nozzle blowing the inert gas. When the stripping temperature is lower than 170° C., quenching is too quick, resulting in a substantially amorphous alloy structure. On the other hand, when the stripping temperature is higher than 350° C., too many fine crystal grains are formed.

Because an inner portion of the stripped Fe-based, primary, ultrafine crystalline alloy ribbon is still at a relatively high temperature, the Fe-based, primary, ultrafine crystalline alloy ribbon is sufficiently cooled before winding to prevent further crystallization. For example, the stripped Fe-based, primary, ultrafine crystalline alloy ribbon is wound after cooled to substantially room temperature by blowing an inert gas (nitrogen, etc.).

[3] Fe-Based, Nano-Crystalline, Soft-Magnetic Alloy Ribbon

The Fe-based, primary, ultrafine crystalline alloy ribbon of the present invention is heat-treated at a temperature equal to or higher than the crystallization temperature, to form an Fe-based, nano-crystalline, soft-magnetic alloy ribbon comprising fine crystal grains (nano-crystals) having an average grain size of 20-100 nm precipitated in a proportion of 50% or more by volume in an amorphous matrix. The Fe-based, nano-crystalline, soft-magnetic alloy ribbon has relative permeability of about 4000-6000, and excellent soft-magnetic properties. Though the crystallization temperature differs depending on the composition, the heat treatment temperature is preferably 500-580° C. The heat treatment time is preferably 30 minutes or less, more preferably 10-20 minutes.

[4] Magnetic Devices

Because magnetic devices formed by the Fe-based, nano-crystalline, soft-magnetic alloy ribbons have high saturation magnetic flux densities, they are suitable for high-power applications in which high magnetic saturation is important, for example, large-current reactors such as anode reactors; choke coils for active filters; smoothing choke coils; magnetic pulse power devices used in laser power supplies, accelerators, etc.; magnetic cores for transformers, communications pulse transformers, motors and power generators; current transformers in current detection circuits used in wind power generators, etc.

The present invention will be explained in more detail referring to Examples below without intention of restricting the present invention thereto.

### EXAMPLE 1

Fe-based, primary, ultrafine crystalline alloy ribbons of 53 mm in width, 10-24 μm in thickness and 5000 m in length having compositions of Fe_{75.7-x}NiₓCu_{0.8}Nb_{2.8}Si_{10.9}B_{9.8} were produced by casting under the following conditions by a single roll method, stripped from a cooling roll by a nitrogen gas stream (air knife), and wound around a roll.

Gap between nozzle and cooling roll: 250 μm,

Width of nozzle slit: 0.45 mm,

Ejection pressure of melt: 280 g/cm², and

Peripheral speed of cooling roll: 30 m/s.

Ribbons as thick as 10 μm were frequently fractured by tensile stress when wound around a roll, failing to obtain long alloy ribbons. Accordingly, a slitting experiment was not conducted.

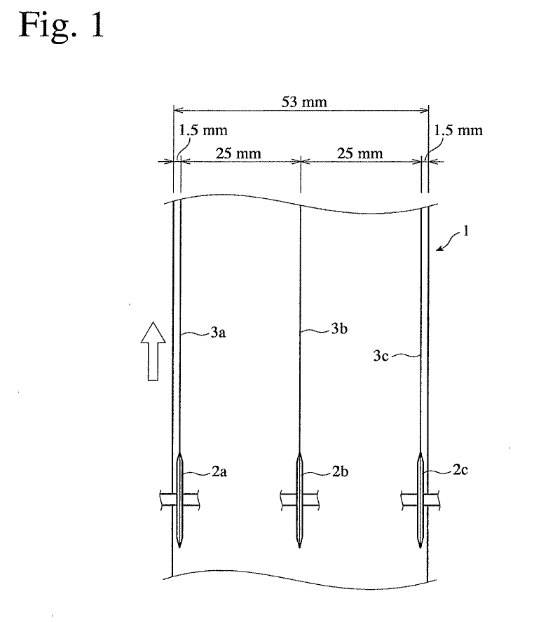

Each of Fe-based, primary, ultrafine crystalline alloy ribbons 1 of 10-24 μm in thickness was slit by three disc grinders 2a, 2b, 2c rotating at substantially the same peripheral speed as the speed of the alloy ribbon 1, as shown in FIG. 1. Each disc grinder 2a, 2b, 2c has a diameter of 50 mm, with a peripheral cutting edge having an angle of 30° in cross section. By rotating three disc grinders 2a, 2b, 2c arranged with the intervals shown in FIG. 1, three cutting lines 3a, 3b, 3c were formed. Slitting along the cutting lines 3a, 3c by the disc grinders 2a, 2c removed both side edge portions of the alloy ribbon 1 each in a width of 1.5 mm, and slitting along the cutting line 3b by the disc grinder 2b divided a center portion of the alloy ribbon 1 to half with a width of 25 mm. Two 25-mm-wide alloy ribbon pieces thus obtained were examined with respect to the frequency of fracturing (the number of occasions of fracturing in the length of 5000 m). The results are shown in Table 1.

TABLE 1

| Ribbon | Frequency of Fracturing (number) | | | | | | | | | | |
|---|---|---|---|---|---|---|---|---|---|---|---|
| Thickness | Ni Content x (atomic %) | | | | | | | | | | |
| (μm) | 1.0 | 3.0 | 4.0 | 4.5 | 4.8 | 5.0 | 5.2 | 5.3 | 6.0 | 7.0 | 10.0 |
| 10 | — ⁽¹⁾ | — | — | — | — | — | — | — | — | — | — |
| 11 | 13 | 8 | 6 | 6 | 3 | 3 | 3 | 5 | 7 | 7 | 12 |
| 12 | 11 | 7 | 5 | 4 | 3 | 3 | 3 | 4 | 5 | 8 | 10 |
| 13 | 5 | 7 | 2 | 1 | 0 | 0 | 0 | 1 | 2 | 7 | 7 |
| 14 | 4 | 3 | 1 | 0 | 0 | 0 | 0 | 0 | 1 | 5 | 7 |
| 16 | 5 | 3 | 0 | 0 | 0 | 0 | 0 | 0 | 0 | 6 | 11 |
| 18 | 4 | 3 | 0 | 0 | 0 | 0 | 0 | 0 | 1 | 10 | 15 |
| 20 | 3 | 3 | 1 | 0 | 0 | 0 | 0 | 0 | 1 | 15 | 12 |
| 22 | 7 | 5 | 1 | 0 | 0 | 0 | 0 | 0 | 1 | 9 | 11 |
| 23 | 7 | 4 | 2 | 1 | 0 | 0 | 0 | 1 | 1 | 9 | 15 |
| 24 | 8 | 9 | 5 | 4 | 4 | 4 | 5 | 4 | 6 | 12 | 16 |

Note:
⁽¹⁾ Fracturing occurred frequently in winding, failing to obtain a long alloy ribbon.

As is clear from Table 1, the frequency of fracturing was 2 or less with the Ni content in a range of 4-6 atomic % and the thickness in a range of 13-23 μm. Particularly with the Ni content in a range of 4.5-5.3 atomic % and the thickness in a range of 14-22 μm, no fracture was observed at all. This indicates that to achieve slitting without fracture, the Ni content should be in a range of 4-6 atomic %, and the alloy ribbon thickness should be in a range of 13-23 μm. Outside the above ranges, there was a high frequency of fracturing even when one of the Ni content and thickness requirements was met, failing to obtain satisfactory slittability.

The structure of each alloy ribbon shown in Table 1 was observed by a transmission electron microscope (magnification: 100,000 times), to measure the volume ratio of fine crystal grains. As a result, fine crystal grains having grain sizes of more than 300 nm were not observed in any alloy ribbons. The results are shown in Table 2.

TABLE 2

| Ribbon | Volume Ratio of Fine Crystal Grains (% by volume) | | | | | | | | | | |
|---|---|---|---|---|---|---|---|---|---|---|---|
| Thickness | Ni Content x (atomic %) | | | | | | | | | | |
| (μm) | 1.0 | 3.0 | 4.0 | 4.5 | 4.8 | 5.0 | 5.2 | 5.3 | 6.0 | 7.0 | 10.0 |
| 11 | 15.1 | 11.7 | 10.5 | 9.8 | 12.7 | 10.1 | 11.1 | 10.1 | 12.9 | 13.0 | 23.7 |
| 12 | 11.1 | 7.5 | 9.3 | 8.8 | 10.5 | 9.4 | 9.0 | 8.1 | 8.8 | 15.1 | 19.6 |
| 13 | 8.7 | 8.0 | 6.9 | 6.8 | 6.5 | 6.4 | 6.0 | 6.1 | 4.1 | 13.0 | 13.2 |
| 14 | 6.9 | 9.7 | 6.1 | 3.1 | 2.3 | 2.3 | 3.4 | 2.3 | 2.1 | 8.8 | 14.6 |
| 16 | 8.8 | 7.9 | 4.1 | 2.4 | 1.6 | 1.8 | 2.1 | 3.1 | 3.7 | 10.1 | 21.4 |
| 18 | 11.1 | 8.8 | 3.7 | 3.1 | 1.9 | 2.0 | 2.3 | 2.9 | 3.9 | 19.1 | 30.2 |
| 20 | 17.4 | 10.9 | 3.9 | 2.8 | 2.7 | 2.3 | 2.7 | 2.7 | 2.1 | 21.3 | 23.9 |
| 22 | 17.3 | 15.7 | 4.2 | 3.5 | 2.1 | 2.3 | 3.1 | 3.5 | 4.0 | 16.8 | 21.7 |
| 23 | 19.0 | 18.8 | 6.9 | 6.6 | 6.8 | 7.0 | 7.0 | 6.8 | 6.9 | 17.0 | 30.2 |
| 24 | 20.2 | 19.1 | 17.9 | 12.7 | 9.7 | 9.1 | 11.1 | 7.9 | 10.5 | 23.3 | 32.3 |

As is clear from Table 2, the volume ratio of fine crystal grains was 7.0% or less in any alloy ribbons, when the Ni content was in a range of 4-6 atomic %, and when the thickness was in a range of 13-23 μm. Particularly with the Ni content in a range of 4.5-5.3 atomic % and the thickness in a range of 14-22 μm, the volume ratio of fine crystal grains was 3.5% or less.

### EXAMPLE 2

Among alloy ribbons slit to a width of 25 mm in Example 1, those having a Ni content of 4.0 atomic %, 4.5 atomic %, 5.0 atomic %, 5.3 atomic % and 6.0 atomic %, respectively, and a thickness of 16 μm were wound to a toroidal shape having an outer diameter of 24.5 mm and an inner diameter of 21 mm, to form magnetic cores. Each magnetic core was heat-treated at 550° C. for 20 minutes in a nitrogen atmosphere, in a magnetic field of 319.1 kA/m (4000 Gauss), to form nano-crystals having an average grain size of 20-100 nm in the alloy ribbon, thereby obtaining toroidal magnetic cores of Fe-based, nano-crystalline, soft-magnetic alloy ribbons. The observation of a transmission electron photomicrograph (field: 1000 nm×1000 nm) revealed that nano-crystals in each alloy ribbon were substantially spherical, having an average grain size of 20-100 nm and a volume ratio of 60-80% per the entire structure.

A coated copper wire of 0.5 mm in diameter was wound by 1 turn around each toroidal magnetic core, to measure inductance in a magnetic field of 0.05 A/m with a frequency of 10 kHz. Relative permeability μr was calculated from the measured inductance. As the Ni content increased from 4 atomic % to 6 atomic %, the relative permeability μr decreased from 6000 to 4000. Toroidal magnetic cores formed by alloy ribbons having Ni contents of 4.5 atomic %, 5.0 atomic % and 5.3 atomic %, respectively, had relative permeability μr of 5500, 5000 and 4500, respectively.

### EXAMPLE 3

Among alloy ribbons slit to a width of 25 mm in Example 1, that having a Ni content of 5.0 atomic % and a thickness of 16 μm was wound to a toroidal shape having an outer diameter of 150 mm and an inner diameter of 100 mm, to form a magnetic core. A coated copper wire was wound around this toroidal magnetic core to form a common mode choke coil. With this common mode choke coil disposed in an inverter circuit for electric trains, a noise reduction effect was confirmed.

### EXAMPLE 4

When the toroidal magnetic core of Example 3, around which a coated copper wire was wound, was used as a current transformer in a current detection circuit for wind power generators, its capability of detecting current was confirmed.

### EXAMPLE 5

53-mm-wide alloy ribbons having the compositions and thicknesses shown in Table 3 were produced by a single roll method in the same manner as in Example 1. The observation of the structures of as-cast alloy ribbons by a transmission electron microscope revealed that the volume ratios of fine crystal grains in any ribbons were 3.2% or less as shown in Table 3. Fine crystal grains having grain sizes of more than 300 nm were not observed either.

Each alloy ribbon was subject to slitting shown in FIG. 1 to examine the frequency of fracturing. As a result, the frequency of fracturing was zero in any alloy ribbons. This indicates that any alloy ribbons did not suffer fracturing at all by slitting.

TABLE 3

| | | | Volume |
|---|---|---|---|
| | | Frequency of | Ratio of Fine |
| Composition of Alloy Ribbon | Thickness | Fracturing | Crystal Grains |
| (atomic %) | (μm) | (number) | (%) |
| Fe_{70.7}Ni_{5.0}Cu_{0.4}Nb_{4.0}Si_{10.9}B_{9.0} | 18 | 0 | 3.1 |
| Fe_{70.7}Ni_{5.0}Cu_{1.5}Nb_{2.1}Si_{10.9}B_{9.8} | 16 | 0 | 2.7 |
| Fe_{70.7}Ni_{5.0}Cu_{0.8}Nb_{2.8}Si_{10.9}B_{9.8} | 14 | 0 | 2.3 |
| Fe_{70.7}Ni_{5.0}Cu_{0.8}Nb_{2.8}Si_{8.9}B_{11.8} | 22 | 0 | 1.9 |
| Fe_{70.7}Ni_{5.0}Cu_{0.8}Nb_{2.8}Si_{12.9}B_{7.8} | 20 | 0 | 3.2 |

### EXAMPLE 6

An Fe-based, primary, ultrafine crystalline alloy ribbon of 16 μm in thickness and 53 mm in width was produced in the same manner as in Example 1, except for changing the composition to Fe_{72.5}Ni_{5.0}Cu_{0.8}Nb_{1.0}Si_{10.9}B_{9.8}, in which the Ni content was 5.0 atomic %, and the Nb content was 1.0 atomic %. This alloy ribbon was subject to slitting shown in FIG. 1 without fracture.

### EXAMPLE 7

An Fe-based, primary, ultrafine crystalline alloy ribbon of 16 μm in thickness and 53 mm in width was produced in the same manner as in Example 1, except for changing the composition to Fe_{73.0}Ni_{5.0}Cu_{0.8}Nb_{0.5}Si_{10.9}B_{9.8}, in which the Ni content was 5.0 atomic %, and the Nb content was 0.5 atomic %. This alloy ribbon was subject to slitting shown in FIG. 1 without fracture.

### EFFECTS OF THE INVENTION

Because the Fe-based, primary, ultrafine crystalline alloy ribbon of the present invention is formed by an Fe—Ni—Cu—Nb—Si—B alloy comprising 4-6 atomic % of Ni and 0.1-4 atomic % of Nb, and having an as-cast structure in which fine crystal grains having a grain size distribution of 300 nm or less are dispersed in a proportion of more than 0% and 7% or less by volume in an amorphous matrix; and a thickness of 13-23 μm, it can be formed in a large width such that it is dividable to desired widths by slitting without fracture, resulting in high productivity. The Fe-based, primary, ultrafine crystalline alloy ribbon divided to desired widths can be heat-treated to form Fe-based, nano-crystalline, soft-magnetic alloy ribbons having a high saturation magnetic flux density, which may be used for various magnetic devices.

1. An Fe-based, primary, ultrafine crystalline alloy ribbon having a composition represented by the following general formula:
Fe_{100-x-y-z-a-b}NiₓCu_{y}Nb_{z}SiₐB_{b},
wherein x, y, z, a and b are numbers (expressed by atomic %) meeting the conditions of 4≦x≦6, 0.1≦y≦2, 0.1≦z≦4, 7≦a≦18, and 4≦b≦12;
an as-cast structure in which fine crystal grains having a grain size distribution of 300 nm or less are dispersed in a proportion of more than 0% and 7% or less by volume in an amorphous matrix; and
a thickness of 13-23 μm.

2. The Fe-based, primary, ultrafine crystalline alloy ribbon according to claim 1, wherein said fine crystal grains have an average grain size of 80 nm or less.

3. The Fe-based, primary, ultrafine crystalline alloy ribbon according to claim 1, wherein x meets the condition of 4.5≦x≦5.3; wherein the proportion of said fine crystal grains to the entire alloy structure is more than 0% and 3.5% or less by volume; and wherein said alloy ribbon has a thickness of 14-22 μm.

4. A magnetic device formed by an Fe-based, nano-crystalline, soft-magnetic alloy ribbon obtained by heat-treating the Fe-based, primary, ultrafine crystalline alloy ribbon recited in claim 1 at a temperature equal to or higher than its crystallization temperature after slit to a desired width; said Fe-based, nano-crystalline, soft-magnetic alloy ribbon having a structure in which fine crystal grains having an average grain size of 20-100 nm are dispersed in a proportion of 50% or more by volume in an amorphous matrix.
